(19) United States
(12) Patent Application Publication
(10) Pub. No.: US 2009/0020077 A1
(43) Pub. Date: Jan. 22, 2009

(54) Training Leash

(76) Inventor: Adina Macrae, Halifax (CA)

Correspondence Address: Frank J. Bonini Jr.;Harding, Earley, Follmer & Frailey, 86 The Commons at Valley Forge East, 1288 Valley Forge Road, P.O. Box 750, Valley Forge, PA, 19482, US

(21) Appl. No.: 12/224,236

(22) PCT Filed: Mar. 12, 2007
(86) PCT No.: PCT/CA2007/000388

§ 371 Date: Aug. 21, 2008

(30) Foreign Application Priority Data
Mar. 22, 2006 (CA) 2540835

(51) Int. Cl. A01K 15/02; A01K 27/00

(52) U.S. Cl. 119/719; 119/795; 119/796

(57) ABSTRACT

A training device allows the user to control an animal on a lead and enables the emission of audible signals for instructing the animal. The device comprises a leash, one end portion of which is purposed to be gripped by a user, while the end portion remote from the user is structured for connection to an animal. A sound producing element includes a sound actuator operably positioned in the leash structure for ready actuation by the user's fingers, thus facilitating quick sound actuation by the user for animal instruction utilizing audible training signals.

### FIELD OF THE INVENTION

The invention relates generally to devices used for training animals. More particularly, the invention relates to a training device which can be used to emit audible signals as a means for instructing an animal, and at the same time allow the user to restrain the animal during the training exercises.

### BACKGROUND OF THE INVENTION

Many dog owners train their dogs to accomplish certain tasks, using verbal or sign instructions coupled with positive reinforcement. Other methods involve the use of electronic devices that generate electrical signals for shocking the animal if they do not obey the trainer's command, or if they are otherwise disobedient. These devices can be either directly controlled by the trainer, who decides when to shock the animal, or can be adapted to be worn by the animal and automatically generate a shocking signal when a negative behaviour is sensed. A drawback of such devices, which include collars and hand-held electrical prods for discouraging dog barking, is that they are commonly perceived by the general public to be inhumane.

Recently there has been movement toward the generally more humane way of training dogs by using positive reinforcement, which frequently involves the use of treats, verbal praise or play. In this way a dog can learn to associate a behaviour with a positive external reinforcement. Trainers who use positive reinforcement methods often employ a training clicker as an external stimulus. The clicker is used as a training tool for the animal to associate the correct behaviour with the audible signal or click. The clicker is typically used in combination with rewards to provide an effective means of training the animal.

Commercially available clickers are usually made of a plastic housing with a metal plate that produces a clicking noise when depressed by the trainer's thumb or finger. They are relatively small handheld devices that can be carried in the trainer's pocket. Canadian Patent Application No. 2,445,475 (Mugford) describes such a clicker capable of producing discreet clicks when operated by a user. The clicker includes an elongated casing with an opening to accommodate the user's finger or thumb, and a clicker strip fixed at one end within the casing. The volume and the tone of the clicks can be changed using a slider acting on the clicker strip.

Some trainers use a combination of food treats and click signals to train animals. United States Patent Application Publication No. 2005/0183674 (Zutis et al.) describes a handheld device for such purpose. The device includes a palm sized housing including a treat retaining compartment, and a sound producing element retained within the housing. A button disposed on the housing produces noise when depressed, and dispenses a treat from the treat retaining compartment.

Similarly, United States Patent Application Publication No. 2004/0134434 (Kraft et al.) describes a treat dispensing device which includes a dispenser for dispensing individual treats, and a clicking mechanism associated with the dispenser for providing a clicking noise to signal and reward an animal each time the dispenser is operated to dispense a treat. The clicking mechanism includes a structure which is biased into an engagement with the inner surface of the dispenser wheel. The inner surface has a plurality of circumferentially spaced grooves corresponding in number to the compartments, so that a clicking noise is made each time the dispenser wheel is rotated to expose another compartment.

For training exercises using the commonly known clickers or other such devices, the trainer is required to use two hands to manage the leash and the clicker. This may be awkward if the animal must be restrained or if one of the trainer's hands is otherwise occupied e.g. when handing out rewards. In addition, when hand signals are used in place of or in addition to a spoken command, keeping one hand free is required. Attempts have been made in the past to solve this problem. U.S. Pat. No. 4,681,303 (Grassano) describes a manually held leash including a shock absorbent connector for diminishing the effect of the force or strain transmitted when the animal suddenly and forcibly pulls or jumps. The connector can also be fitted with a command sound to order the animal to halt, sit or otherwise cease its troublesome activity.

U.S. Pat. No. 5,494,002 (Greene) describes an animal training device comprising a trigger extending laterally from the body thereof to contact the leash. The trigger is responsive to force such that tensioning of the leash activates a sound generator to startle the animal into walking safely at the owner's side.

A significant disadvantage found in the automated nature of the above devices is that the trainer does not have control over issuing the sound commands.

### SUMMARY OF THE INVENTION

It is accordingly an object of the present invention to provide a training device that is convenient to use and which allows the trainer to restrain and/or control the animal, and at the same time emit audible signals for instructing the animal.

It is also an object of the present invention to provide a device which, using one hand, allows for both maintaining the animal in control when the animal is on leash, and at the same time emitting audible signals for instructing the animal.

According to an aspect of the invention there is provided a device for training animals using audible training signals, said device comprising:
a leash structure for connection to an animal, with a handle for gripping by a user; and
a sound producing element operably configured within said handle and comprising an actuator; said actuator being so dimensioned and positioned as to enable quick sound actuation by the user, thus facilitating animal instruction utilizing audible training signals.

According to another aspect of the invention, there is provided a device for training animals using audible training signals, said device comprising a strap for wrapping around a leash or a leash handle, said device comprising:
a sound producing element positioned on a surface of said strap and comprising a sound actuator; and
operable securing means positioned at or near first and second ends of said strap to releasably attach said first and second ends to each other, whereby said strap can be adjusted for access to said sound actuator for training animals using audible training signals.

In yet another aspect of the invention there is provided a device for training animals using audible training signals, said device comprising:
a leash structure for connection to an animal, with a handle for gripping by a user; and
a sound producing element operably configured within said handle and comprising an actuator; said actuator being so dimensioned and positioned as to enable quick sound actuation by the user, thus facilitating animal instruction utilizing audible training signals.

By providing the training device of the present invention, it is envisioned that more people will take advantage of the benefits of clicker training. Also, people who already use this method of training will find that the present invention makes it easier and more convenient to apply their method of training. Furthermore, incorporating the sound producing device, e.g. clicker, into the leash frees up one of the trainer's hands and makes the clicker available anytime the dog is on leash or when the leash is in the trainer's hand.

### BRIEF DESCRIPTION OF THE DRAWINGS

For a more complete understanding of the present invention and the advantages thereof, reference is made to the following description taken in conjunction with the accompanying figures, in which:

FIG. 1 illustrates a side view of an example of the animal training device according to a first embodiment of the present invention showing a thumb actuated clicker mechanism.

FIG. 2 illustrates a side view of an example of the animal training device according to a first embodiment of the present invention showing an index-finger actuated clicker mechanism.

FIG. 3 illustrates an example of a clicker-strap in an open position according to a second possible embodiment of the present invention,

FIG. 4 illustrates the clicker-strap of FIG. 3 when in a closed position,

FIG. 5 illustrates the clicker-strap of FIGS. 3 and 4 wrapped and secured to a leash,

FIG. 6 illustrates a side view of another example of the animal training device of an embodiment of the present invention, showing an index-finger actuated clicker mechanism,

FIG. 7 illustrates a side view of a further example of an embodiment of the animal training device of the present invention with a thumb actuated clicker mechanism, and

FIG. 8 illustrates a side view of yet another example of an embodiment of the animal training device of the present invention, illustrating a set of clips in the handle of the leash for receiving a separate clicker.

### DETAILED DESCRIPTION OF THE INVENTION

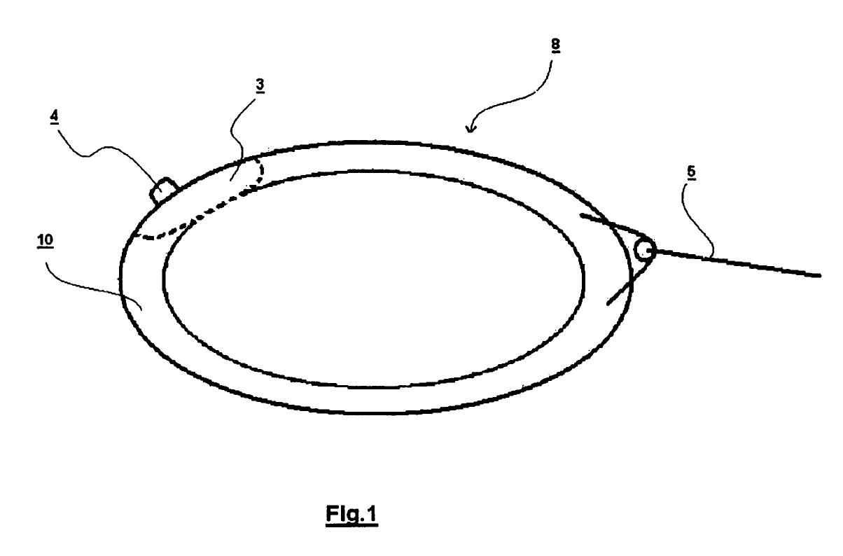

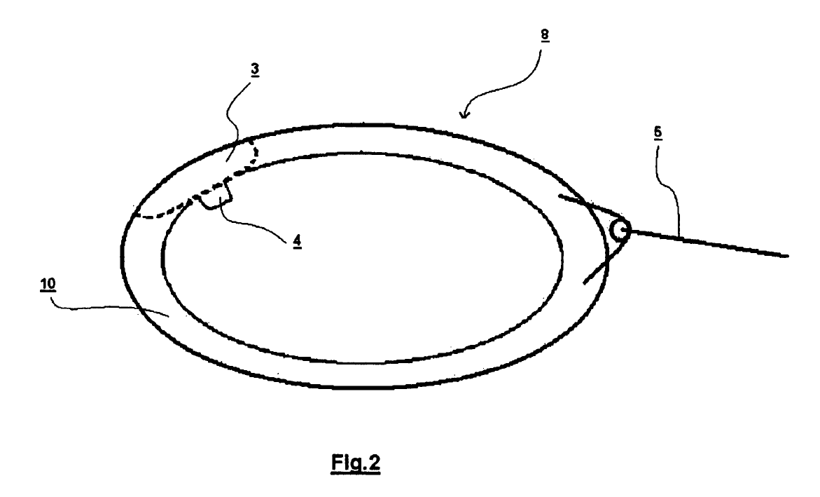

FIG. 1 illustrates an animal training device 8 according to a first embodiment of the invention. As illustrated, the animal training device 8 incorporates a leash that is structured to facilitate connection to an animal through a lead 5. The animal training device 8 includes sound producing means or element 3, in the present example a clicker incorporated into the strap 10 of the leash with an opening therein from which an actuator or button 4 protrudes to the outside for access by the user's fingers. When depressed by the user, the actuator 4 engages the clicker 3 to produce a clicking sound for instructing the animal. In the example shown in FIG. 1 the opening is provided on the inner side of the strap for access by the user's index-finger. However, the opening and actuator 4 can also be provided on the outer side of the strap 10 for access by the user's thumb as illustrated in FIG. 2. It is also contemplated that the clicker can be attached to the leash using other attaching means (not shown) i.e. Velcro™, clips, etc. without being incorporated therein.

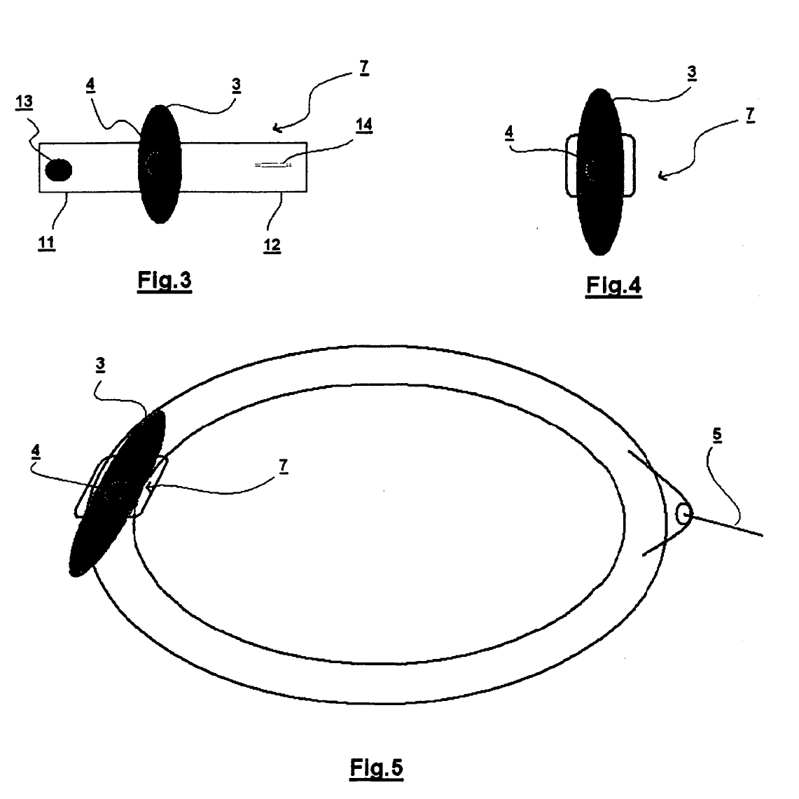

Referring now to FIGS. 3 to 5, there is illustrated an example of another possible embodiment of the invention. FIGS. 3 and 4 show a clicker-strap 7 in an open and closed position, respectively. The clicker-strap 7 is a strap that is designed to releasably wrap around and secure to a leash or a leash handle. The strap has first 11 and second 12 ends that are designed to attach to each other using attaching means 13, for example buttons, Velcro™, clips, pins etc. as shown in FIG. 5. FIG. 3 illustrates a button 13 and slot 14 as a possible example of the attaching means. The first 11 and second 12 ends of the strap can be designed to attach to each other at different positions therealong to allow for adjustment of the circumference of the clicker strap when in closed position. In this way, the clicker strap can be used with different leashes or leash handles, and also with different sizes thereof. Alternatively, the strap can be made of an elastic material which automatically retracts after being pulled to a certain position.

The clicker-strap 7 comprises a clicker 3 attached to the strap for facilitating access thereto by a user's fingers, thereby facilitating training/instructing of an animal when attached to a leash. The clicker-strap 7 allows the user to adjust the position of the clicker with respect to the position of his/her fingers when the user wants to start or stop using the clicker, or when the user wants to switch from the thumb to the index or the other fingers during a training session, or vice-versa. The latter design allows the trainer/user to use the same clicker 3 with different leashes and different kinds of leashes i.e. retractable leashes, regular leashes etc. and also to detach the clicker-strap 7 to put away or store. The clicker 3 can be attached to the strap using Velcro™, clips, pins, or adhesives etc.

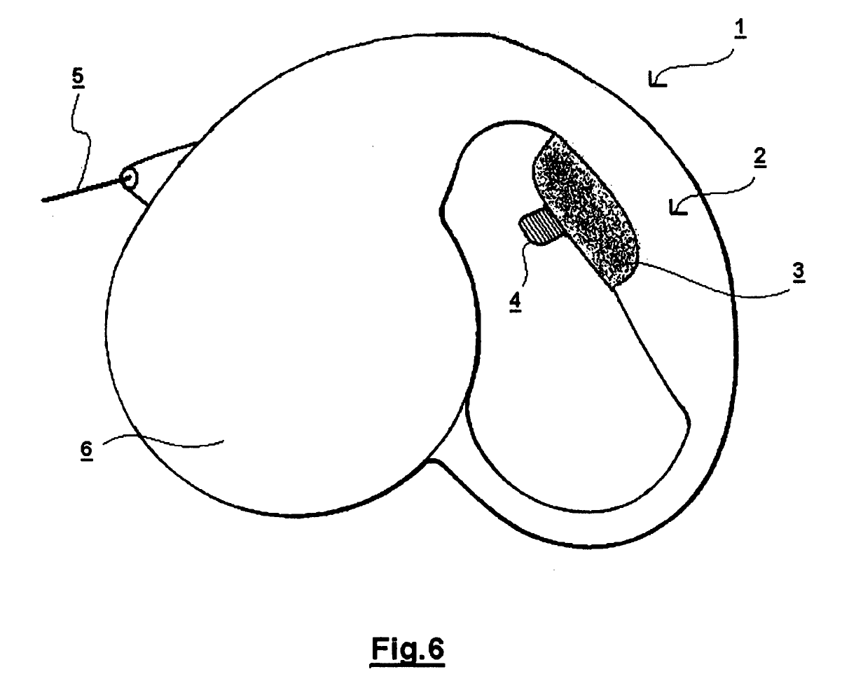

FIG. 6 illustrates a device 1 according to another example of a possible embodiment of the invention. As illustrated, the device 1 incorporates a retractable leash structured to facilitate connection to an animal through a retractable lead 5. Any commonly known lead retraction mechanism may be incorporated in the body 6 of the device to allow for retraction and locking/release of the lead to facilitate training/walking of the animal in proximity to the trainer.

The device 1 includes a handle 2 and clicker 3 incorporated into the handle 2. In FIG. 6 the clicker is located on the inner side of the handle 2 with an actuator or button 4 conveniently positioned within reach of the user's fingers. When depressed by the user, the actuator 4 engages the clicker 3 to produce a clicking sound for instructing the animal.

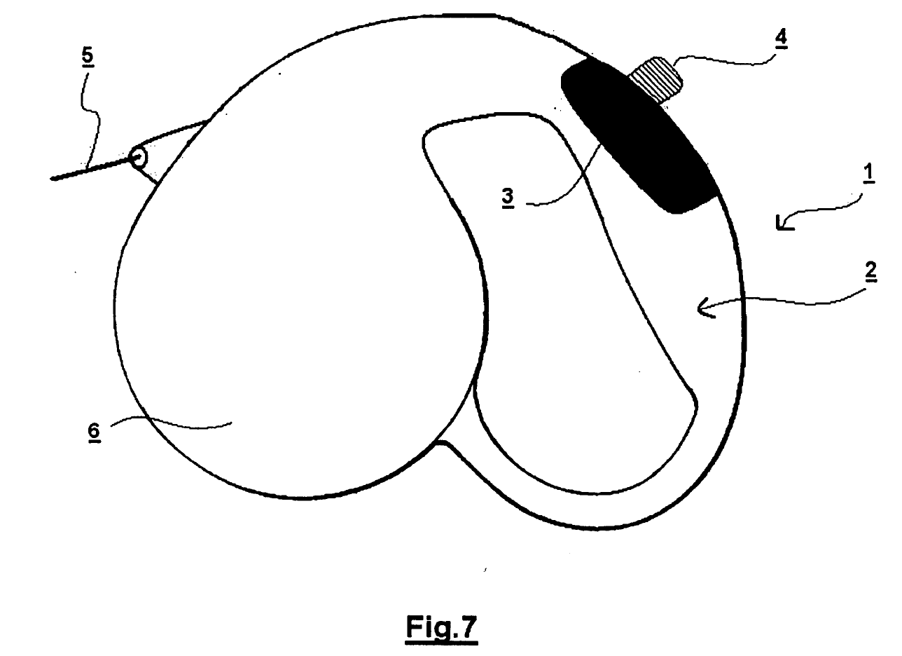

As illustrated in FIG. 7, the clicker 3 may be located on the outer side of the handle to be accessed by the user's thumb when holding the leash handle 2.

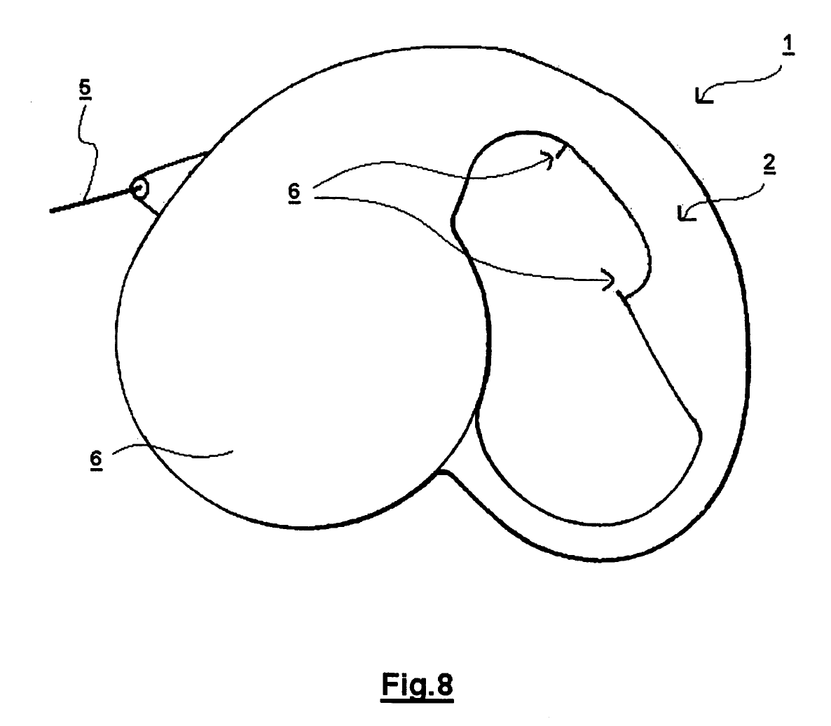

In yet another possible design, the clicker 3 can be detachably secured between the leash handle via attachment means, such as for instance Velcro™, screws, clips, etc. The handle 2 may also include grooves 6 therein for receiving the clicker 3, as illustrated in FIG. 8.

The clicker 3 illustrated in the drawings can be a conventional clicker which uses a mechanical structure to produce the clicking sound. Alternatively, it is also contemplated that an electronic or computerized circuit including a battery, an amplifier and a speaker etc. may be used for producing the desired sound (not shown). In the latter case, the body 6 of the leash may include one or more openings therein for a clear emission of the sound from the speaker. The actuator 4 would then comprise a switch that, when depressed by the user, would trigger the electronic circuit and produce pre-recorded or pre-programmed audible signals.

While the actuator 4 shown in the drawings is illustrated as a protruding button to facilitate its engagement by the user, it is contemplated that any kind of actuator or design may be used for this purpose.

While the clicker-strap 7 is shown in the drawings as being used with a conventional leash, it is contemplated that it could also be used with a retractable leash for facilitating access of the users fingers to the actuator or button of the clicker 3 for instructing/training animals.

The clicker 3 may have a contoured shape to decrease wear on the leash handle material, and for comfort when being held.

The leash, clicker and strap can be made of any material or combination of materials used in the art, particularly materials that provide flexibility and durability, and which can be cleaned such as nylon, plastic, leather etc. and can also have different sizes and dimensions to match with the size of the animal.

Although preferred embodiments of the invention have been disclosed in detail, it will be understood that the invention may be implemented in alternate embodiments and that various changes and modifications may be made to the embodiments illustrated herein without departing from the spirit of the invention or the scope thereof as defined in the following claims.

1. A device for training animals using audible training signals for the positive reinforcement of desirable animal behavior, said device comprising:
a. a leash structure adapted for connection to an animal; and
b. a sound producing element operably positioned within the leash structure and including a sound actuator within the leash structure, said actuator being so dimensioned and positioned as to enable sound actuation by the user for the positive reinforcement of desirable animal behavior, thus facilitating positive reinforcement animal instruction utilizing audible training signals.

2. A device according to claim 1, wherein the leash comprises a handle, and wherein the actuator is positioned on an interior surface of said handle.

3. A device according to claim 1, wherein the leash comprises a handle, and wherein the actuator is mounted on an exterior surface of said handle.

4. A device according to claim 1, wherein the actuator is a button-like structure.

5. A device according to claim 4, wherein the button-like structure protrudes above a normal outer surface of the leash to facilitate ready contact therewith in the process of animal instruction.

6. A device according to claim 5, wherein the button-like structure protrudes above the normal outer surface of the leash structure through an opening formed in the leash structure to facilitate ready contact therewith in the process of animal instruction.

7. A device according to claim 1, wherein the sound producing element is a clicker.

8. A device according to claim 7, wherein that portion of the sound producing element protruding above the normal outer surface of the leash is shaped in the form of a section of a curved annulus.

9. A device according to claim 1, wherein the sound producing element is detachably secured to the leash by operable securing means.

10. A device according to claim 9, wherein the operable securing means is selected from at least one of the group consisting of Velcro™, screws, clips, and grooves provided in the leash for receiving the sound producing element.

11. A device according to claim 1, wherein the sound producing element is an electronic sound producing device.

12. A device according to claim 9, wherein the sound producing element is an electronic sound producing device.

13. A device according to claim 11, wherein the actuator is a switch.

14. A device according to claim 1, wherein the leash is made of nylon, plastic, or leather.

15. A device for training animals using audible training signals for the positive reinforcement of desirable animal behavior, said device comprising a strap for wrapping around a leash or a leash handle, said device comprising:
a. a sound producing element positioned on a surface of said strap and comprising a sound actuator; and
b. operable securing means positioned at or near first and second ends of said strap to releasably attach said first and second ends to each other, whereby said strap can be adjusted for access to said sound actuator for training animals using audible training signals for the positive reinforcement of desirable animal behavior.

16. A device according to claim 15, wherein the operable securing means is selected from at least one of the group consisting of Velcro™, buttons, pins or and clips.

17. A device according to claim 15, wherein the sound producing element is attached to the strap using attachment means selected from at least one of the group consisting of Velcro™, buttons, pins, clips or and adhesives.

18. A device according to claim 15, wherein the strap is made of an elastic material.

19. A device according to claim 15, wherein said first and second ends of the strap are adapted to facilitate attachment to each other at different positions therealong.

20. A device for training animals using audible training signals for the positive reinforcement of desirable animal behavior, said device comprising:
a. a leash structure for connection to an animal, with a handle for gripping by a user; and
b. a sound producing element operably configured within said handle and comprising an actuator; said actuator being so dimensioned and positioned as to enable sound actuation by the user for the positive reinforcement of desirable animal behavior, thus facilitating positive reinforcement animal instruction utilizing audible training signals.

21. A device according to claim 20, wherein the actuator is mounted on an exterior surface of said handle.

22. A device according to claim 20, wherein the actuator is mounted on an interior surface of said handle.

23. A device according to claim 20, wherein the actuator is a button-like structure.

24. A device according to claim 23, wherein the button-like structure protrudes above a normal outer surface of the handle through an opening formed in the leash structure to facilitate ready contact therewith in the process of animal instruction.

25. A device according to claim 20, wherein the sound producing element is a clicker.

26. A device according to claim 25, wherein that portion of the sound producing element protruding above the normal outer surface of the leash is shaped in the form of a section of a curved annulus.

27. A device according to claim 20, wherein the sound producing element is incorporated into the handle.

28. A device according to claim 20, wherein the sound producing element is detachably secured to the leash by operable securing means.

29. A device according to claim 28 wherein the operable securing means is selected from at least one of the group consisting of Velcro™, screws, clips, or and grooves positioned in the handle for receiving the sound producing element.

30. A device according to claim 20, wherein the sound producing element is an electronic sound producing device.

31. A device according to claim 30, wherein said actuator is a switch.

32. A device according to claim 30, wherein the sound producing element is incorporated into the leash.

33. A device according to claim 32, wherein the sound producing element is incorporated in the handle of the leash.

34. A device according to claim 20, wherein the leash is made of nylon, plastic, or leather.

35. A device according to claim 20, wherein the leash is a retractable leash comprising a retracting mechanism effective to facilitate retraction, locking, and release of the lead.

36. A method for training an animal using audible training signals for the positive reinforcement of desirable animal behavior, comprising the steps of:
a. providing a device for training animals using audible training signals for the positive reinforcement of desirable animal behavior, said device comprising:
i. a leash structure adapted for connection to an animal:
ii. a sound producing element operably positioned within the leash structure and including a sound actuator within the leash structure, said actuator being so dimensioned and positioned as to enable quick sound actuation by the user for the positive reinforcement of desirable animal behavior: and
b. having a user connect the leash to the animal and train the animal by actuating the sound actuator to produce a sound to positively reinforce desirable animal behavior.
